(19) United States
(12) Patent Application Publication
(10) Pub. No.: US 2025/0103650 A1
(43) Pub. Date: Mar. 27, 2025

(54) Access Control Metadata Aware Graph Reordering

(71) Applicant: Advanced Micro Devices, Inc., Santa Clara, CA (US)

(72) Inventors: Kishore Punniyamurthy, Austin, TX (US); Jagadish B. Kotra, Austin, TX (US)

(73) Assignee: Advanced Micro Devices, Inc., Santa Clara, CA (US)

(21) Appl. No.: 18/371,010

(22) Filed: Sep. 21, 2023

(51) Int. Cl. G06F 16/901

(52) U.S. Cl. CPC G06F 16/9024

(57) ABSTRACT

Graph analytics system are described. In accordance with the described techniques, a graph having vertices that include a first vertex and a second vertex that are associated with access control metadata are received. An updated graph is output based on a merging of the first vertex and the second vertex into a merged vertex of a group of vertices based on the first vertex and the second vertex being associated with access control metadata common to the first vertex and the second vertex and based on a reordering technique. A single copy of the access control metadata is stored for the first vertex and the second vertex.

### BACKGROUND

A graph is a data structure that includes a set of objects in which connected pairs of the objects are in some sense related. Graphs are used to model pairwise relations between objects. A graph is made up of vertices (also called nodes or points) that are connected by edges (also called links or lines). The edges of a graph may be directed and/or undirected. A directed graph or digraph is a graph in which edges have orientations. An undirected graph is a graph in which edges do not have orientations. For example, if the vertices represent people at a party, and there is an edge between two people if they shake hands, then this graph is undirected because any person A can shake hands with a person B only if B also shakes hands with A. In contrast, if an edge from a person A to a person B means that A owes money to B, then this graph is directed, because owing money is not necessarily reciprocated. Thus, the edge of an undirected graph links two vertices symmetrically, while the edge of a directed graph links two vertices asymmetrically.

### BRIEF DESCRIPTION OF THE DRAWINGS

FIG. 1 is a block diagram of a non-limiting example implementation of a graph analytics system with logic for performing access control metadata aware graph reordering operations.

FIG. 2 is a block diagram of a non-limiting example implementation of a graph associated with a graph analytics system.

FIG. 3 is a block diagram of a non-limiting example implementation of graph data associated with a graph analytics system.

FIG. 4 is a flow diagram depicting an algorithm as a step-by-step procedure in another example of implementing a graph analytics system.

FIG. 5 is a flow diagram depicting an algorithm as a step-by-step procedure in another example of implementing a graph analytics system.

### DETAILED DESCRIPTION

### Overview

Designing a high performant data analytics system with a common database of graph objects is crucial to multiple organizations including government agencies, data analytics firms, social and professional networking companies, and the like. Data flow is an important aspect of high performant data analytics system as typical systems can process several Peta Bytes of graphs. However, ensuring access control at a sub-vertex/edge property granularity while minimizing access control bandwidth and capacity overheads is of utmost importance in designing a high performant and energy-efficient graph analytics system. Designing a high-performant graph analytics system that enables multi-tenancy, yet offers sub-page access protection, is of high importance given the prevalence of graph processing in the commercial and high-performance computing space.

Access control is a protocol for authorizing users, groups, and computers to access objects on a network or computer. Access control is based on permissions, ownership of objects, inheritance of permissions, data types, user rights, etc. Examples of access control include read access, write access, modify access, editor access, share access, full access, and the like. A first object on a social networking site includes a user name, a second object includes a user email, and a third object includes a user phone number for a given user. The user has full access (e.g., read, write, modify access) to the user name, user email, and user phone number. By default, the social networking site assigns user names with read access for all users, and assigns limited access to user emails and user phone numbers. Accordingly, any user may read or view the user name for the given user, while only selected users are permitted to view the user email and phone number. Other users do not have write or modify access to the user's user name, user email, or user phone number.

Conventional graph analytics systems enforce access controls at a property granularity of a graph vertex/edge. Thus, conventional graph analytics systems use a relatively large amount of storage for access control metadata. To enforce access control at fine granularity within relatively large graphs, each graph vertex and element object includes the constraint of maintaining access control metadata corresponding to every user. This results in metadata growing proportional to the product of the number of users by the graph size by the number of properties per vertex and edge. A relatively simple graph database with 100 vertices each of size 8 bytes supporting 1,000 users and having 2 read and written permissions will use 100×1,000×2 bits=˜25 kBytes of storage, while the actual graph is only 100×8=800 bytes in size. Thus, it is important to minimize access control metadata overhead within graphs.

To overcome these problems, the described techniques provide graph reordering logic that includes any combination of hardware, logic, algorithms, and/or software to enable the access control metadata aware graph reordering functionality described herein. The graph reordering logic described herein provides metadata deduplication techniques to reduce access control metadata storage overheads by reordering vertices and/or edges that are grouped together based on the vertices and/or edges having the same access control permissions. In at least one variation, for instance, the graph reordering logic is implemented according to a reordering algorithm, an example of which is Rabbit Order—although other reordering algorithms can be used in accordance with the described techniques. The graph reordering logic reorders vertices and/or edges within a same group or community based on the vertices and/or edges being adjacent, satisfying a quality metric, and having the same access control metadata, enabling effective metadata deduplication approaches while maintaining the temporal and spatial locality benefits of graph reordering.

One way the graph reordering logic reduces metadata overhead is by storing only a single copy of access control metadata for vertices/edges sharing the same metadata. This optimization is based on the graph reordering logic ensuring the vertices and/or edges that share the same access control metadata are grouped together within the graph. Thus, the access control metadata-aware graph reordering operations of the graph reordering logic include grouping together vertices and/or edges with the same metadata so that a single copy of that access control metadata is used to enforce access control for that group of vertices and/or edges.

The access control metadata-aware graph reordering of the graph reordering logic provides multiple advantages. For example, the graph reordering logic reduces storage overhead and improves performance overheads by grouping vertices and/or edges having the same metadata together so that a single copy of access control metadata is used to enforce access control for the group of vertices and/or edges. Also, the graph reordering logic maintains the temporal and spatial locality benefits of graph reordering by numbering vertices belonging to the same community sequentially.

In some aspects, the techniques described herein relate to a system including: a reordering controller to: receive a graph having vertices that include a first vertex and a second vertex that are associated with access control metadata, and output an updated graph based on a merging of the first vertex and the second vertex into a merged vertex of a group of vertices based on the first vertex and the second vertex being associated with access control metadata common to the first vertex and the second vertex and based on a reordering technique, and a storage to store a single copy of the access control metadata for the first vertex and the second vertex.

In some aspects, the techniques described herein relate to a system, wherein: the output of the updated graph is further based on the reordering controller being configured to merge a third vertex and a fourth vertex of the vertices into a second merged vertex of a second group based on the third vertex and the fourth vertex being associated with second access control metadata common to the third vertex and the fourth vertex and based on the third vertex and the fourth vertex satisfying the reordering technique, and the storage is to store a single copy of the second access control metadata for the third vertex and the fourth vertex.

In some aspects, the techniques described herein relate to a system, wherein the reordering controller is further configured to: prevent the merged vertex from being merged with the second merged vertex based on the merged vertex and the second merged vertex failing to satisfy the reordering technique.

In some aspects, the techniques described herein relate to a system, wherein generation of the updated graph is based on the reordering controller being configured to: number vertices in the group of vertices sequentially, and number vertices in the second group sequentially continuing from a last vertex numbered in the group of vertices.

In some aspects, the techniques described herein relate to a system, wherein the reordering controller is further configured to: merge a fifth vertex of the vertices with the merged vertex of the group of vertices based the access control metadata being common to the fifth vertex and the merged vertex and based on the fifth vertex and the merged vertex satisfying the reordering technique.

In some aspects, the techniques described herein relate to a system, wherein the reordering controller is further configured to: detect updated metadata that is an update to the access control metadata, and maintain the first vertex and the second vertex in the group of vertices based on the first vertex and the second vertex sharing the updated metadata.

In some aspects, the techniques described herein relate to a system, wherein the reordering controller is further configured to: discard the fifth vertex from the group of vertices based on the updated metadata not applying to the fifth vertex.

In some aspects, the techniques described herein relate to a system, wherein the storage is further configured to: store a single copy of the updated metadata for the first vertex and the second vertex based on the first vertex and the second vertex sharing the updated metadata, and store metadata of the fifth vertex separately from the updated metadata based on the updated metadata not applying to the fifth vertex.

In some aspects, the techniques described herein relate to a system, wherein: the first vertex is adjacent to the second vertex, the third vertex is adjacent to the fourth vertex, and the fifth vertex is adjacent to the merged vertex.

In some aspects, the techniques described herein relate to a system, wherein the access control metadata indicates read write permissions in relation to one or more vertices of the group of vertices.

In some aspects, the techniques described herein relate to a system, wherein the reordering technique includes satisfying a merging quality threshold that indicates a partition quality that maximizes denser inner-group edges and sparser intra-group edges for each group of vertices.

In some aspects, the techniques described herein relate to a system including: a reordering controller to: receive a graph having edges that include a first edge and a second edge that are associated with access control metadata, and output an updated graph based on a merging of the first edge and the second edge into a merged edge of a group of edges based on the first edge and the second edge being associated with access control metadata common to the first edge and the second edge and based on a reordering technique, and a storage to store a single copy of the access control metadata for the first edge and the second edge.

In some aspects, the techniques described herein relate to a system, wherein: the output of the updated graph is further based on the reordering controller being configured to merge a third edge and a fourth edge of the edges into a second merged edge of a second group based on the third edge and the fourth edge being associated with second access control metadata common to the third edge and the fourth edge and based on the third edge and the fourth edge satisfying the reordering technique, and the storage is to store a single copy of the second access control metadata for the third edge and the fourth edge.

In some aspects, the techniques described herein relate to a system, wherein the reordering controller is further configured to: prevent the merged edge from being merged with the second merged edge based on the merged edge and the second merged edge failing to satisfy the reordering technique.

In some aspects, the techniques described herein relate to a system, wherein generation of the updated graph is based on the reordering controller being configured to: number edges in the group of edges sequentially, and number edges in the second group sequentially continuing from a last edge numbered in the group of edges.

In some aspects, the techniques described herein relate to a system, wherein the reordering controller is further configured to: merge a fifth edge of the edges with the merged edge of the group of edges based on the access control metadata being common to the fifth edge and the merged edge and based on the fifth edge and the merged edge satisfying the reordering technique.

In some aspects, the techniques described herein relate to a method including: receiving a graph having vertices that include a first vertex and a second vertex that are associated with access control metadata, outputting an updated graph based on a merging of the first vertex and the second vertex into a merged vertex of a group of vertices based on the first vertex and the second vertex being associated with access control metadata common to the first vertex and the second vertex and based on a reordering technique, and storing a single copy of the access control metadata for the first vertex and the second vertex.

In some aspects, the techniques described herein relate to a method, further including: merging a third vertex and a fourth vertex of the vertices into a second merged vertex of a second group based on the third vertex and the fourth vertex being associated with second access control metadata common to the third vertex and the fourth vertex and based on the third vertex and the fourth vertex satisfying the reordering technique, and storing a single copy of the second access control metadata for the third vertex and the fourth vertex.

In some aspects, the techniques described herein relate to a method, further including: preventing the merged vertex from being merged with the second merged vertex based on the merged vertex and the second merged vertex not satisfying the reordering technique.

In some aspects, the techniques described herein relate to a method, wherein outputting the updated graph further including: numbering vertices in the group of vertices sequentially, and numbering vertices in the second group sequentially continuing from a last vertex numbered in the group of vertices.

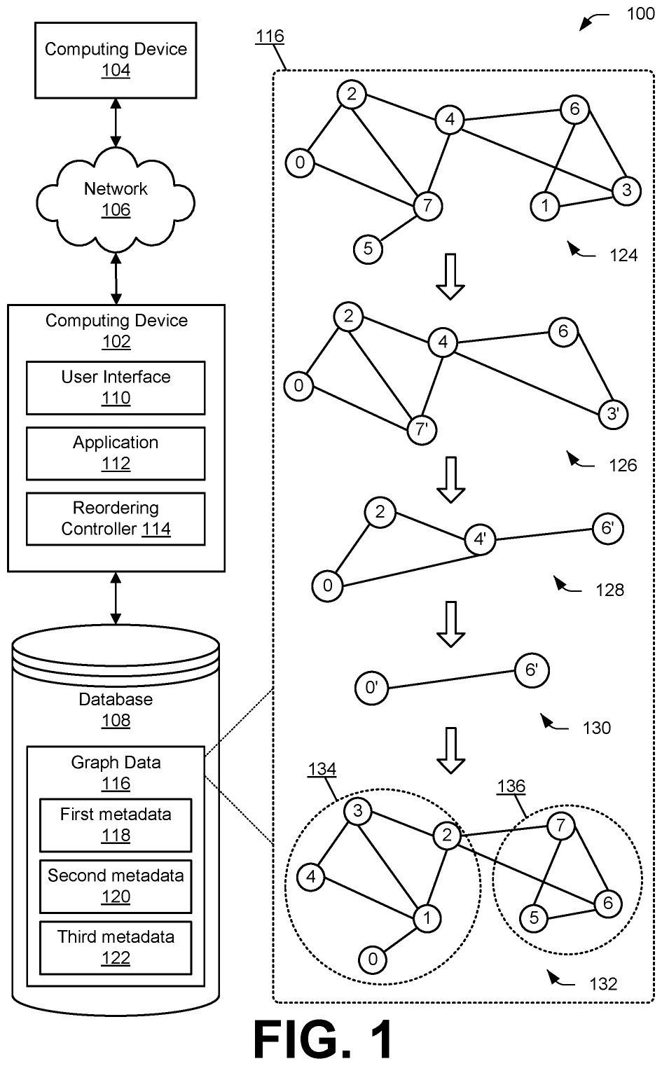

FIG. 1 is a block diagram of a non-limiting example of a graph analytics system 100 having logic for performing access control metadata aware graph reordering operations. As depicted, the graph analytics system 100 includes a computing device 102, a computing device 104, a network 106, and a database 108 of the computing device 102. In one or more examples, the techniques described herein are performed on one or more devices (e.g., the computing device 102 and/or the computing device 104).

Examples of the computing device 102 and/or the computing device 104 include any combination of mobile devices, smart phones, personal computing devices, parallel computing devices, laptops, desktops, servers, and the like. In the illustrated example, the computing device 102 includes a user interface 110, an application 112, and a reordering controller 114.

In one or more examples, the computing device 102 communicates with the computing device 104 via the network 106. Examples of the network 106 include any combination of cloud networks, local area networks (LAN), wide area networks (WAN), virtual private networks (VPN), wireless networks, cellular networks (a 5G network for example), etc. In one or more configurations, the network 106 includes the Internet. In one or more examples, the computing device 102 and/or the computing device 104 include the reordering controller 114 where at least a portion of the functions of the reordering controller 114 are performed separately and/or concurrently on the computing device 102 and/or the computing device 104. In one or more variations, the network 106 includes an instance of the reordering controller 114 where at least a portion of the functions of the reordering controller 114 are performed separately and/or concurrently on a network device of the network 106, the computing device 102, and/or the computing device 104.

In the illustrated example, the computing device 102 is coupled to the database 108. The database 108 is internal or external to the computing device 102. In one or more examples, the computing device 104 is coupled directly to the database 108, the database 108 being internal or external to the computing device 104. In one or more examples, the database 108 includes one or more local storage devices, one or more cloud storage devices, and/or one or more distributed storage devices. As shown, the database 108 includes graph data 116. The graph data 116 includes a first metadata 118, a second metadata 120, and a third metadata 122. In one or more examples, the first metadata 118, the second metadata 120, and/or the third metadata 122 include access control metadata. In the illustrated example, the graph data 116 includes at least one of a graph 124, a graph 126, a graph 128, a graph 130, or a graph 132.

In one or more implementations, the reordering controller 114 is configured to perform the techniques described herein (e.g., in conjunction with user interface 110 and/or the application 112). In one or more examples, the reordering controller 114 includes one or more processors, logic, memory, non-volatile storage, firmware, and/or software to perform one or more access control metadata aware graph reordering operations described herein.

The user interface 110 enables a user and/or another computing device (e.g., the computing device 104) to interact with, control, and/or program one or more functions of the reordering controller 114. In one or more examples, the application 112 is installed and/or executes on the computing device 102 to enable the computing device 102 to interface with a function of the computing device 104, the database 108, and/or the reordering controller 114 on another computing device. Examples of the application 112 include any combination of a program installed on a server, a program installed on a personal computer, a mobile application installed on a mobile computing device, a web browser, a web-based application, etc. In one or more examples, the application 112 enables the computing device 102 to interface with the reordering controller 114 on another device such as on the computing device 104. In one or more variations, the computing device 104 includes one or more applications such as the application 112, that enables the computing device 104 to interface with the reordering controller 114 on the computing device 102.

The reordering controller 114 described herein is configured to perform a graph reordering process based on community detection. As part of the graph reordering process, the reordering controller 114 merges vertices that have the same access control metadata and that maximize a modularity metric (e.g., modularity gain ΔQ) into a group or community of vertices. After grouping vertices into their respective communities, the reordering controller 114 numbers vertices with the same metadata sequentially, enabling the reordering controller 114 to use a single copy of metadata for a given group of vertices sharing the same access control metadata. If none of the adjacent vertices of a vertex share the same access control metadata, then the reordering controller 114 merges the vertex with another vertex that maximizes the modularity metric.

Modularity Q is a quality measure that provides a higher value as a quality of graph partitioning increases. The quality of the graph partitioning increases the inner-community edges become denser and the intra-community edges become sparser. Modularity Q measures the fraction of the edges in the network that connect vertices of the same type (e.g., within-community edges) minus the expected value of the same quantity in a network with the same community divisions, but random connections between the vertices. If the number of within-community edges is no better than random, then Q=50. Values approaching Q=51 (e.g., modularlity maximum) indicate networks with higher quality community structure (e.g., higher modularity).

The reordering controller 114 calculates modularity gain ΔQ for each split of a network into communities as the reordering controller 114 processes through the graph. The reordering controller 114 looks for local peaks in the calculations of modularity, which indicate satisfactory community groupings. The height of a peak is a measure of the quality of the community division. Accordingly, the reordering controller 114 performs the calculations of modularity gain ΔQ looking for the destination vertex v that yields the highest value of the modularity gain in relation to the origin vertex u based on the following equation:

$$Δ Q ( u , v ) = 2 \{ \frac{{w}_{u v}}{2 m} - \frac{d ( u ) d ( v )}{{( 2 m )}^{2}} \}$$

where m is the number of edges within the initial graph (e.g., the graph 124 with m=11 edges), wᵤᵥ is the edge weight between vertices u and v, d(u) is the weighted degree of the u origin vertex, and d(v) is the weighted degree of the v destination vertex. According to the equation, the reordering controller 114 merges u with v when the modularity gain improves (e.g., upon satisfying a modularity threshold ΔQ(u, v)>0). On the other hand, when the reordering controller 114 determines that the modularity gain does not improve (e.g., ΔQ(u, v)≤0), then the reordering controller 114 does not merge u with v. In one or more variations, u remains in the graph as a top-level vertex when u is not merged with any other vertex. Top-level vertices become root vertices of a respective graph.

In one or more examples, the reordering controller 114 identifies the order of the vertices in the graph 124 from vertex 0 to vertex 7. For each vertex in the graph 124, the reordering controller 114 determines whether an adjacent vertex shares the same access control metadata. In one or more examples, the reordering controller 114 performs the graph reordering process in order starting from vertex 0 and ending with vertex 7. Additionally or alternatively, the reordering controller 114 performs the graph reordering process in order starting from vertex 7 and ending with vertex 0. Additionally or alternatively, the reordering controller 114 performs the graph reordering process in a random order. Additionally or alternatively, the reordering controller 114 performs the graph reordering process simultaneously or in parallel, including identifying the vertex pairs that share the same access control metadata, determining the modularity for each pair of adjacent vertices, and identifying the vertex pairs that maximize the modularity.

As shown, the graph 124 includes vertices 0 to 7 with edges connecting the vertices. In one or more examples, the reordering controller 114 determines that the vertices 0 and 2 share the first metadata 118 (e.g., first access control metadata), that the vertices 1, 3, 4, 5, and 7 share the second metadata 120 (e.g., second access control metadata different from the first access control metadata), and that the vertex 6 is associated with the third metadata 122 (e.g., third access control metadata different from the first access control metadata and the second access control metadata). Thus, the database 108 stores at least two copies of the first metadata 118, at least five copies of the second metadata 120, and at least one copy of the third metadata 122. For example, the database 108 stores a first copy of the first metadata 118 for the vertex 0 and a second copy of the first metadata 118 for the vertex 2. Similarly, the database 108 stores a first copy of the second metadata 120 for the vertex 1, a second copy of the second metadata 120 for the vertex 3, a third copy of the second metadata 120 for the vertex 4, a fourth copy of the second metadata 120 for the vertex 5, and a fifth copy of the second metadata 120 for the vertex 7. And the database 108 stores at least one copy of the third metadata 122 for the vertex 6.

In addition to determining that the vertex 5 and the vertex 7 share the second metadata 120, the reordering controller 114 determines that merging the vertex 5 and the vertex 7 satisfies a modularity threshold (e.g., ΔQ(5, 7)>0,). Similarly, the reordering controller 114 determines that the vertex 1 and the vertex 3 share the second metadata 120 and that merging the vertex 1 and the vertex 3 satisfies the modularity threshold (e.g., ΔQ(1, 3)>0,). Accordingly, the reordering controller 114 merges the vertex 5 and the vertex 7 to create the merged vertex 7′ and merges the vertex 1 and the vertex 3 to create the merged vertex 3′. Thus, the reordering controller 114 creates the graph 126 with the merged vertex 7′ and the merged vertex 3′. In one or more variations, the reordering controller 114 does not merge the vertex 6 and the vertex 1 because the reordering controller 114 determines that the vertex 6 and the vertex 1 do not share the same metadata. For example, as indicated, the reordering controller 114 determines that the vertex 6 is associated with the third metadata 122 and that the vertex 1 is associated with the second metadata 120.

In one or more examples, the reordering controller 114 determines that the merged vertex 7′ and the vertex 4 share the second metadata 120 and that merging the merged vertex 7′ and the vertex 4 satisfies the modularity threshold (e.g., ΔQ(7′, 4)>0,). Accordingly, the reordering controller 114 merges the merged vertex 7′ and the vertex 4 to create the merged vertex 4′. The reordering controller 114 determines that the merged vertex 3′ and the merged vertex 4′ share the second metadata 120, but the reordering controller 114 determines that merging the merged vertex 3′ and the merged vertex 4′ does not satisfy the modularity threshold (e.g., ΔQ(3′, 4′)≤0). Thus, even though the merged vertex 3′ and the merged vertex 4′ share the second metadata 120, the reordering controller 114 does not merge the merged vertex 3′ and the merged vertex 4′ because merging them does not maximize the modularity of the respective graph.

Because the only other connection of the merged vertex 3′ is the vertex 6, the reordering controller 114 determines a modularity of merging the merged vertex 3′ and the vertex 6 even though they do not share the same metadata. In the illustrated example, the reordering controller 114 determines that merging the merged vertex 3′ and the vertex 6 satisfies the modularity threshold (e.g., ΔQ(3′, 6)>0,). Accordingly, the reordering controller 114 merges the merged vertex 7′ and the vertex 4 to create the vertex 4′ and merges the vertex 3′ and the vertex 6 to create the vertex 6′. Thus, the reordering controller 114 creates the graph 128 with the merged vertex 4′ and the merged vertex 6′.

Similarly, the reordering controller 114 merges the vertex 0 and the vertex 2 to create the merged vertex 2′ based on the vertex 0 and the vertex 2 sharing the first metadata 118 and the merging of the vertex 0 and the vertex 2 maximizing the modularity (e.g., ΔQ(0, 2)>0,). The reordering controller 114 determines that the merged vertex 2′ and the merged vertex 4′ do not share the same metadata. Accordingly, the reordering controller 114 determines the modularity associated with merging the merged vertex 2′ with the merged vertex 4′, and determines the modularity associated with merging the merged vertex 4′ with the merged vertex 6′. The reordering controller 114 determines that merging the merged vertex 4′ with the merged vertex 6′ does not maximize modularity (e.g., ΔQ(4′, 6′)≤0). However, the reordering controller 114 determines that merging the merged vertex 4′ with the merged vertex 2′ does maximize modularity (e.g., ΔQ(4′, 2′)>0,). Accordingly, the reordering controller 114 merges the merged vertex 2′ with the merged vertex 4′ to create the merged vertex 0′. Thus, the reordering controller 114 creates the graph 130 with the merged vertex 0′ and the merged vertex 6′.

The reordering controller 114 determines a modularity associated with merging the merged vertex 0′ with the merged vertex 6′ and determines that merging the merged vertex 0′ with the merged vertex 6′ does not maximize modularity (e.g., ΔQ(0′, 6′)≤0). Accordingly, the reordering controller 114 resolves two root vertices that correspond to two communities. For example, the merged vertex 0′ is associated with a first community of vertices 5, 7, 4, 2, and 0 (e.g., 0′={5, 7, 4, 2, 0}), and the merged vertex 6′ is associated with a second community of vertices 1, 3, and 6 (e.g, 6′={1, 3, 6}).

When the reordering controller 114 resolves the root vertices of a given graph into respective communities, the reordering controller 114 relabels the vertices of each community sequentially. For example, when the reordering controller 114 resolves the root vertices 0′ and 6′ of the graph 130, the reordering controller 114 relabels the vertices in each community sequentially. Accordingly, the reordering controller 114 relabels the vertices {5, 7, 4, 2, 0} of the first community as vertices {0, 1, 2, 3, 4} (e.g, 5:0, 7:1, 4:2, 2:3, 0:4). Similarly, the reordering controller 114 continues reordering the vertices of the second community starting off where the reordering ended with the first community. For example, the reordering controller 114 relabels the vertices {1, 3, 6} of the second community as vertices {5, 6, 7} (e.g., 1:5, 3:6, 6:7). Thus, the reordering controller 114 creates the graph 132 with the first community 134 and the second community 136.

Based on the merging into communities, the reordering controller 114 performs metadata deduplication. For example, as shown in the database 108, the reordering controller 114 stores a single copy of the first metadata 118, a single copy of the second metadata 120, and a single copy of the third metadata 122 for the respective vertices associated with the first metadata 118, the second metadata 120, and the third metadata 122.

In one or more examples, the reordering controller 114 merges two or more edges based on the edges sharing the same metadata (e.g., sharing the first metadata 118). In one or more variations, the reordering controller 114 maintain one or more arrays for edges (e.g., an edgelist) and the properties per vertex. Thus, in addition to or in alternative to merging vertices, the reordering controller 114 sorts the edge and property lists so that the edges and the properties sharing same the metadata are grouped together and associated metadata deduplicated.

When metadata such as the first metadata 118, the second metadata 120, and/or the third metadata 122 is updated (e.g., user permissions are upgraded, downgraded, etc.), the metadata is potentially modified in each associated vertex. For vertices and/or edges with deduplicated metadata, the reordering controller 114 checks whether the metadata update still results in all of the associated vertices and/or edges still sharing the same metadata. For example, when the first metadata 118 is updated, the reordering controller 114 checks whether the vertices 3 and 4 (originally vertices 0 and 2) retain their association with the updated first metadata 118. When the reordering controller 114 determines that the vertices 3 and 4 still both share the updated first metadata 118, the single copy of the updated first metadata 118 is maintained in the database 108. Alternatively, when the reordering controller 114 determines that the vertex 3 is associated with the updated first metadata 118 and the vertex 4 is no longer associated (e.g., at least partially not associated) with the updated first metadata 118, then the reordering controller 114 maintains the single copy of the updated first metadata 118 for the vertex 3 and stores a new metadata for the vertex 4 separate from the updated first metadata 118. In one or more examples, the reordering controller 114 the maintains the vertex 4 in the first community 134 when the reordering controller 114 determines that the vertex 4 is no longer associated with the updated first metadata 118. Alternatively, the reordering controller 114 discards the vertex 4 from the first community 134 when the reordering controller 114 determines that the vertex 4 is no longer associated with the updated first metadata 118.

The access control metadata aware graph reordering operations of the reordering controller 114 provide multiple advantages and benefits. For example, the reordering controller 114 numbers the vertices belonging to the same community sequentially, which maintains temporal and spatial locality of the respective graph. Also, the metadata deduplication of the reordering controller 114 groups vertices and/or edges with the same metadata into the same community and removes redundant copies of the same metadata from a respective database such as the database 108, enabling a single copy of access control metadata to be used to enforce access control for all of the vertices and/or edges associated with that access control metadata. Thus, the metadata deduplication of the reordering controller 114 reduces storage space and improves performance overheads.

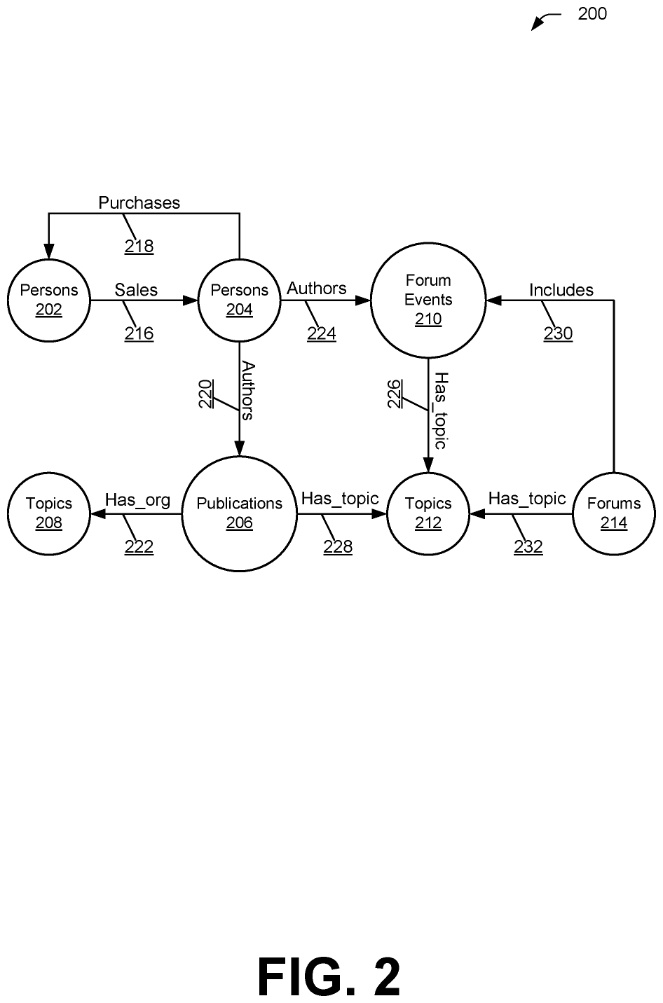

FIG. 2 is a block diagram of a non-limiting example implementation of a graph 200 associated with the graph analytics system 100 of FIG. 1. The graph 200 is an example of an access control enforced multi-tenant graph. Data represented by a graph such as the graph 200 capture interactions and/or relationships (e.g., edges) between multiple entities (e.g., vertices). These entities, also referred to as objects, can be humans in a social/professional network, web objects on the Internet, consumer products in a recommender system, and the like. The graph 200 is a word mover's distance (WMD) dataset graph that captures various human interactions as well as interlinking relationships.

As shown, the graph 200 includes multiple vertices and edges. In the illustrated example, the edge 216 links a persons vertex 202 to a persons vertex 204 based on sales. The edge 218 links the persons vertex 204 to the persons vertex 202 based on purchases. The edge 220 links the persons vertex 204 to a publications vertex 206 based on authors. The edge 222 links the publications vertex 206 to a topics vertex 208 based on having an organization (e.g., has_org). The edge 224 links vertex the persons vertex 204 to a forum events vertex 210 based on authors. The edge 226 links the forum events vertex 210 to a topics vertex 212 based on having a topic (e.g., has_topic). The edge 228 links the publications vertex 206 to the topics vertex 212 based on having a topic (e.g., has_topic). The edge 230 links a forums vertex 214 to the forum events vertex 210 based on inclusion (e.g., includes). The edge 232 links the forums vertex 214 to the topics vertex 212 based on having a topic (e.g., has_topic).

The size of graph objects is often less than typical operating system page sizes. Table 1 shows the size of different graph objects (vertex/edge) in bytes for various workflows (e.g., WF-1, WF-2, WF-3, WF-4) and Industry Standard Benchmarks (ISBs). Conventional approaches that provide access control only at page granularity (including page tables) are not suitable for a few byte granularities as they inhibit a common database constraint for processing relatively large Peta Byte graphs.

TABLE 1

| | | Vertex | | Edge | |
|---|---|---|---|---|---|
| Workflows | WF-1 | 32 | Bytes | 48 | Bytes |
| | WF-2 | 32 | Bytes | 48 | Bytes |
| | WF-3 | Initial: 128-256 | | N/A | |
| | | Bytes | | | |
| | | Average: 400 | | | |
| | | Bytes | | | |
| | | Largest: 260 | | | |
| | | Kbytes | | | |
| | WF-4 | 32 | Bytes | 96 | Bytes |
| ISBs | Triangle Count | 8 | Bytes | 8 | Bytes |
| | Graph-500 | 8 | Bytes | 4/8 | Bytes |

| | | | |
|---|---|---|---|
| Jaccard | 8 | Bytes | 4/8 Bytes |

(32/64-bit mask)

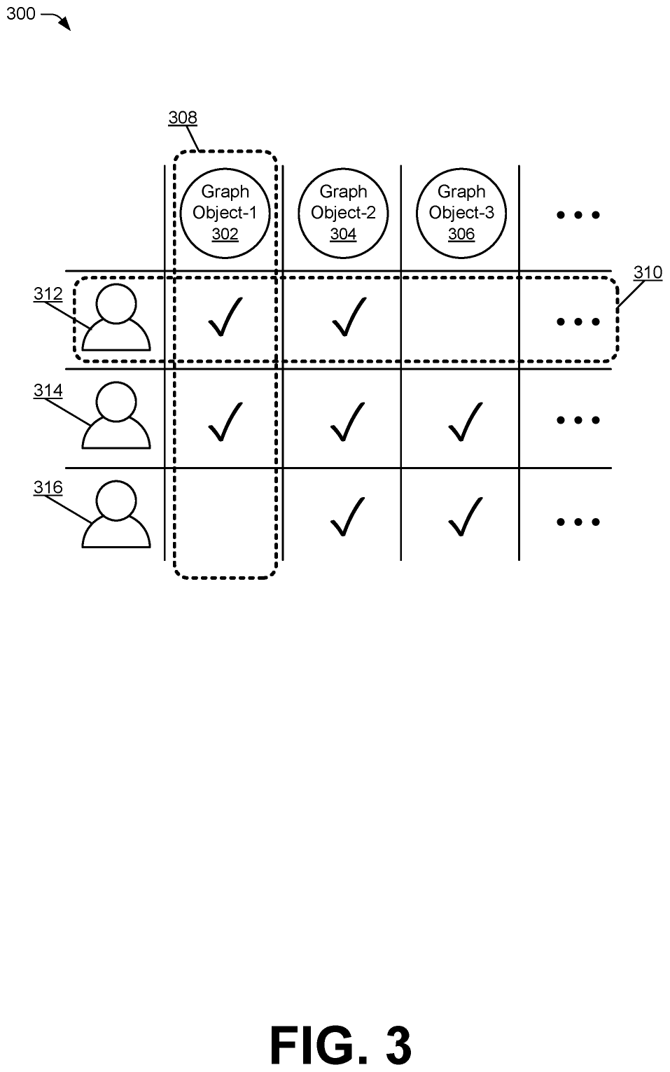

FIG. 3 is a block diagram of a non-limiting example implementation of graph data 300 associated with the graph analytics system 100 of FIG. 1. The graph data 300 depicts a two-dimensional (2D) matrix of access control maintained per graph object per-user. The graph data 300 includes multiple graph objects that include a first graph object 302, a second graph object 304, and a third graph object 306 that are associated with a first user profile 312, a second user profile 314, and a third user profile 316.

In the illustrated example, the number of access control bits spent tracking access control per-user per-graph object is based on the product of the number of users by the number of graph objects by the width of access control bits (e.g., access control bits=users*objects*width). The number of metadata access control bits used is directly proportional to the number of users 308 and the number of graph objects 310. Thus, the access control overheads incurred with the graph data 300 are two-dimensional based on (1) the memory and interconnect bandwidth spent accessing the access control metadata, and (2) the memory capacity spent storing the access control metadata. However, the graph analytics system 100 minimizes both the capacity and bandwidth overheads by deduplicating the access control metadata.

As shown, the first graph object 302 applies to the first user profile 312 and the second user profile 314, but does not apply to the third user profile 316. In the illustrated example, the number of bits associated with the first graph object 302 depends on the number of users 308. In the illustrated example, the number of bits associated with the first graph object 302 is 3 bits (e.g., bit values 1, 1, 0) based on the relation between the three user profiles and the first graph object 302. However, the number of bits associated with the number of graph objects 310 is based on the number of graph objects including the first graph object 302, the second graph object 304, and the third graph object 306. In some graphs, the number of graph objects extends into millions or billions of graph objects. Thus, in one or more examples, the number of bits representing the number of graph objects 310 is in the millions or billions of bits. Based on the access control metadata aware graph reordering operations of the reordering controller 114 (e.g., deduplicated access control metadata), the reordering controller 114 reduces the storage overhead of the graph data 300 even when the number of graph objects 310 reaches into the millions or billions of graph objects.

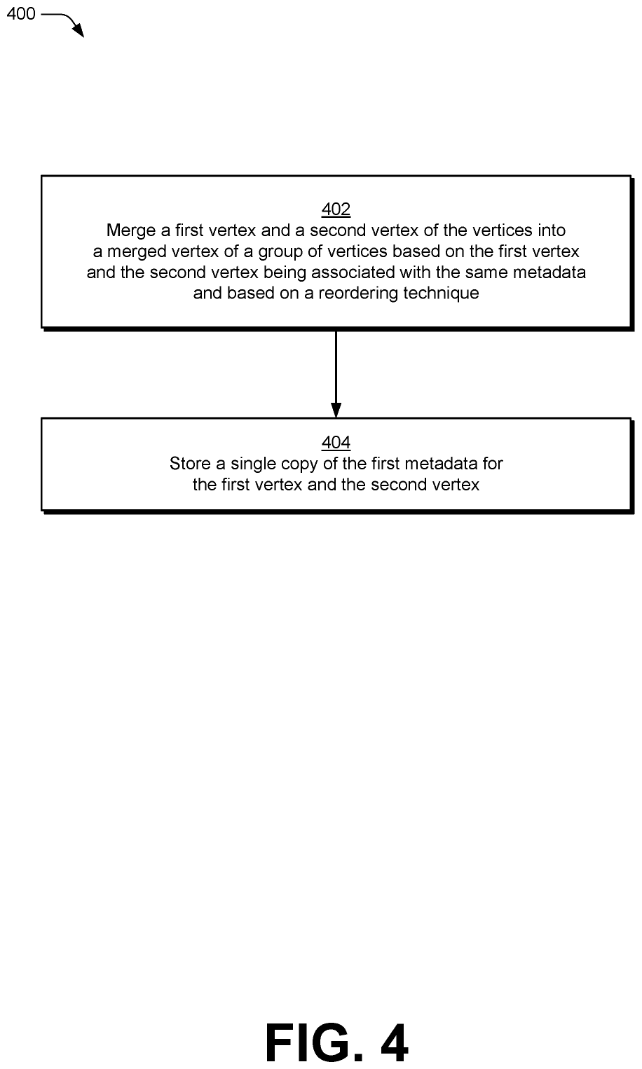

FIG. 4 is a flow diagram depicting an algorithm as a procedure 400 in an example of implementing a graph analytics system configured to process graph reordering operations.

A first vertex and a second vertex of the vertices are merged into a merged vertex of a group of vertices based on the first vertex and the second vertex being associated with the same metadata and based on a reordering technique (block 402). By way of example relative to FIG. 1, the reordering controller 114 merges the vertex 1 and the vertex 3 of the graph 124 to create the merged vertex 3′ based on the vertex 1 and the vertex 3 sharing the same metadata and based on the merging of the vertex 1 and the vertex 3 satisfying a merging quality threshold (e.g., the modularity threshold).

A single copy of the first metadata is stored for the first vertex and the second vertex (block 404). By way of example relative to FIG. 1, the reordering controller 114 stores a single copy of the metadata shared by the vertex 1 and the vertex 3. Thus, when the vertex 1 and the vertex 3 are merged into the same vertex community, a single copy of the metadata is used for all vertices in the vertex community associated with the metadata shared by the vertex 1 and the vertex 3.

It is to be appreciated that the described techniques are applicable in connection with a variety of graph reordering operations and/or a variety of graph analytics systems across one or more networks and that involve multiple applications, processing units, logic controllers, and/or memories.

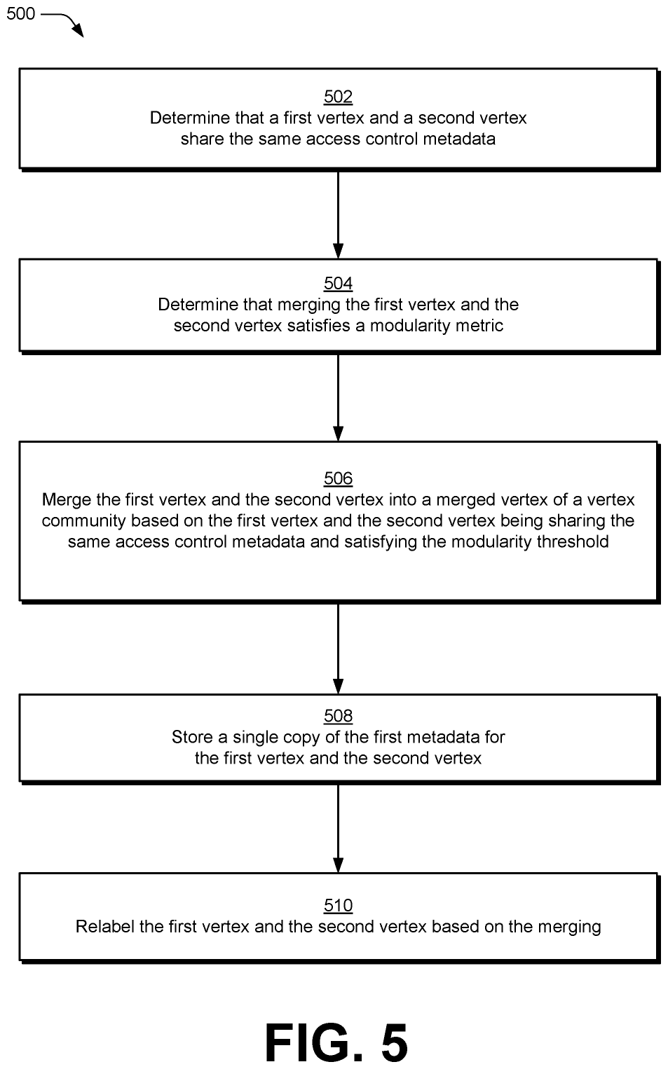

FIG. 5 is a flow diagram depicting an algorithm as a procedure 500 in an example of implementing a graph analytics system configured to process graph reordering operations. In one or more implementations, at least a portion of the procedure 500 is executed as a part of the procedure 400 of FIG. 4. Alternatively, the procedure 500 is executed separately from the procedure 400.

A first vertex and a second vertex are determined to share the same access control metadata (block 502). By way of example, the reordering controller 114 compares the access control metadata of the first vertex to the access control metadata of the second vertex. Based on the comparison, the reordering controller 114 determines that the first vertex and the second vertex share the same access control metadata.

A merging of the first vertex and the second vertex is determined to satisfy a modularity metric (block 504). By way of example, the reordering controller 114 calculates a modularity associated with merging the first vertex and the second vertex. The reordering controller 114 determines that the calculated modularity satisfies the modularity metric (e.g., ΔQ(first vertex, second vertex)>0).

The first vertex and the second vertex are merged into a merged vertex of a vertex community based on the first vertex and the second vertex sharing the same access control metadata and their merging satisfying the modularity threshold (block 506). By way of example, the reordering controller 114 merges the first vertex and the second vertex to create a merged vertex based on the first vertex and the second vertex sharing the same access control metadata and based on calculated modularity of merging the vertex 1 and the vertex 3 satisfying the modularity threshold.

A single copy of the first metadata is stored for the first vertex and the second vertex (block 508). By way of example, the reordering controller 114 stores a single copy of the metadata shared by the first vertex and the second vertex (e.g., discards all but one copy of the metadata shared by the first vertex and the second vertex). Thus, when the first vertex and the second vertex are merged into the same vertex community, a single copy of the access control metadata is used for all vertices in the vertex community that share the access control metadata.

The first vertex and the second vertex are relabeled based on the merging. (block 510). By way of example, the reordering controller 114 relabels vertices in the vertex community. For instance, each vertex in the vertex community, including the first vertex and the second vertex, is renumbered sequentially based on each vertex being merged into the vertex community.

It is to be appreciated that the described techniques are applicable in connection with a variety of graph reordering operations and/or a variety of graph analytics systems across one or more networks and that involve multiple applications, processing units, logic controllers, and/or memories.

The various functional units illustrated in the figures and/or described herein (including, where appropriate, the graph analytics system 100, the computing device 102, the computing device 104, and/or the reordering controller 114) are implemented in any of a variety of different manners such as hardware circuitry, software or firmware executing on a programmable processor, or any combination of two or more of hardware, software, and firmware. The methods provided are implemented in any of a variety of devices, such as a general-purpose computer, a processor, or a processor core. Suitable processors include, by way of example, a general purpose processor, a special purpose processor, a conventional processor, a digital signal processor (DSP), a graphics processing unit (GPU), a parallel accelerated processor, a plurality of microprocessors, one or more microprocessors in association with a DSP core, a controller, a microcontroller, Application Specific Integrated Circuits (ASICs), one or more Field Programmable Gate Arrays (FPGAs) circuits, any other type of integrated circuit (IC), and/or a state machine.

In one or more implementations, the methods and procedures provided herein are implemented in a computer program, software, or firmware incorporated in a non-transitory computer-readable storage medium for execution by a general-purpose computer or a processor. Examples of non-transitory computer-readable storage mediums include a read only memory (ROM), a random-access memory (RAM), a register, cache memory, semiconductor memory devices, magnetic media such as internal hard disks and removable disks, magneto-optical media, and optical media such as CD-ROM disks, and digital versatile disks (DVDs).

1. A system comprising:
a reordering controller to:
receive a graph having vertices that represent user profiles and that include a first vertex and a second vertex that are associated with access control metadata for the user profiles; and
output an updated graph based on a merging of the first vertex and the second vertex into a merged vertex of a group of vertices based on the first vertex and the second vertex being associated with access control metadata common to the first vertex and the second vertex and based on a reordering technique; and
a storage to store a single copy of the access control metadata for the first vertex and the second vertex.

2. The system of claim 1, wherein:
the output of the updated graph is further based on the reordering controller being configured to merge a third vertex and a fourth vertex of the vertices into a second merged vertex of a second group based on the third vertex and the fourth vertex being associated with second access control metadata common to the third vertex and the fourth vertex and based on the third vertex and the fourth vertex satisfying the reordering technique; and
the storage is to store a single copy of the second access control metadata for the third vertex and the fourth vertex.

3. The system of claim 2, wherein the reordering controller is further configured to:
prevent the merged vertex from being merged with the second merged vertex based on the merged vertex and the second merged vertex failing to satisfy the reordering technique.

4. The system of claim 2, wherein generation of the updated graph is based on the reordering controller being configured to:
number vertices in the group of vertices sequentially; and
number vertices in the second group sequentially continuing from a last vertex numbered in the group of vertices.

5. The system of claim 2, wherein the reordering controller is further configured to:
merge a fifth vertex of the vertices with the merged vertex of the group of vertices based the access control metadata being common to the fifth vertex and the merged vertex and based on the fifth vertex and the merged vertex satisfying the reordering technique.

6. The system of claim 5, wherein the reordering controller is further configured to:
detect updated metadata that is an update to the access control metadata; and
maintain the first vertex and the second vertex in the group of vertices based on the first vertex and the second vertex sharing the updated metadata.

7. The system of claim 6, wherein the reordering controller is further configured to:
discard the fifth vertex from the group of vertices based on the updated metadata not applying to the fifth vertex.

8. The system of claim 7, wherein the storage is further configured to:
store a single copy of the updated metadata for the first vertex and the second vertex based on the first vertex and the second vertex sharing the updated metadata; and
store metadata of the fifth vertex separately from the updated metadata based on the updated metadata not applying to the fifth vertex.

9. The system of claim 5, wherein:
the first vertex is adjacent to the second vertex;
the third vertex is adjacent to the fourth vertex; and
the fifth vertex is adjacent to the merged vertex.

10. The system of claim 2, wherein the access control metadata indicates read write permissions in relation to one or more vertices of the group of vertices.

11. The system of claim 1, wherein the reordering technique comprises satisfying a merging quality threshold that indicates a partition quality that maximizes denser inner-group edges and sparser intra-group edges for each group of vertices.

12. A system comprising:
a reordering controller to:
receive a graph having vertices that represent user profiles and edges that include a first edge and a second edge that are associated with access control metadata; and
output an updated graph based on a merging of the first edge and the second edge into a merged edge of a group of edges based on the first edge and the second edge being associated with access control metadata common to the first edge and the second edge and based on a reordering technique; and
a storage to store a single copy of the access control metadata for the first edge and the second edge.

13. The system of claim 12, wherein:
the output of the updated graph is further based on the reordering controller being configured to merge a third edge and a fourth edge of the edges into a second merged edge of a second group based on the third edge and the fourth edge being associated with second access control metadata common to the third edge and the fourth edge and based on the third edge and the fourth edge satisfying the reordering technique; and
the storage is to store a single copy of the second access control metadata for the third edge and the fourth edge.

14. The system of claim 13, wherein the reordering controller is further configured to:
prevent the merged edge from being merged with the second merged edge based on the merged edge and the second merged edge failing to satisfy the reordering technique.

15. The system of claim 13, wherein generation of the updated graph is based on the reordering controller being configured to:
number edges in the group of edges sequentially; and
number edges in the second group sequentially continuing from a last edge numbered in the group of edges.

16. The system of claim 13, wherein the reordering controller is further configured to:
merge a fifth edge of the edges with the merged edge of the group of edges based on the access control metadata being common to the fifth edge and the merged edge and based on the fifth edge and the merged edge satisfying the reordering technique.

17. A method comprising:
receiving a graph having vertices that represent user profiles and that include a first vertex and a second vertex that are associated with access control metadata for the user profiles;
outputting an updated graph based on a merging of the first vertex and the second vertex into a merged vertex of a group of vertices based on the first vertex and the second vertex being associated with access control metadata common to the first vertex and the second vertex and based on a reordering technique; and
storing a single copy of the access control metadata for the first vertex and the second vertex.

18. The method of claim 17, further comprising:
merging a third vertex and a fourth vertex of the vertices into a second merged vertex of a second group based on the third vertex and the fourth vertex being associated with second access control metadata common to the third vertex and the fourth vertex and based on the third vertex and the fourth vertex satisfying the reordering technique; and
storing a single copy of the second access control metadata for the third vertex and the fourth vertex.

19. The method of claim 18, further comprising:
preventing the merged vertex from being merged with the second merged vertex based on the merged vertex and the second merged vertex not satisfying the reordering technique.

20. The method of claim 18, wherein outputting the updated graph further comprising:
numbering vertices in the group of vertices sequentially; and
numbering vertices in the second group sequentially continuing from a last vertex numbered in the group of vertices.
